(19) United States
(12) Patent Application Publication
(10) Pub. No.: US 2006/0111989 A1
(43) Pub. Date: May 25, 2006

(54) Inventory tracking and accounting system and method

(76) Inventors: Barbara Jean Church, East Peoria, IL (US); James Todd Ralston, Chillicothe, IL (US); Timothy John Dominy, Metamora, IL (US); Bradley Paul Gile, Normal, IL (US)

Correspondence Address: CATERPILLAR INC.;100 N.E. ADAMS STREET, PATENT DEPT., PEORIA, IL, 616296490, US

(21) Appl. No.: 11/318,232

(22) Filed: Dec. 23, 2005

Related U.S. Application Data
(63) Continuation of application No. 10/318,851, filed on Dec. 13, 2002.
(60) Provisional application No. 60/344,224, filed on Dec. 21, 2001.

(51) Int. Cl. A01K 5/02; G06F 17/50

(52) U.S. Cl. 705/28; 705/29

(57) ABSTRACT

A system and method track inventory composed of a plurality of items is provided. The system and method includes the steps of establishing ownership of a first number of the items by a first owner, establishing ownership of a second number of the items by a second owner, disposing of one of the items in a transaction, and establishing ownership of the disposed one of the items as a function of a parameter of the transaction.

This application claims the benefit of prior provisional patent application Ser. No. 60/344,224 Filed Dec. 21, 2001.

### TECHNICAL FIELD

The present invention relates generally to a method for tracking inventory, and more particularly, to a method for tracking inventory of a plurality of items among a plurality of owners.

### BACKGROUND

Current inventory tracking techniques are designed for tracking pieces or items of a part type, e.g., part “X” located in a bin, where all of the pieces in the bin are owned by one owner. Therefore, when multiple pieces of the same part type having different owners are tracked, e.g., ten pieces of part X of which five (5) are owned by Owner 1 and five (5) are owned by Owner 2, current inventory tracking systems require that a part type “X” having one owner be physically located in a different location than a part type “X” having another owner. Requiring duplicative storage for each owner of a part type creates a large amount of logistics overhead, both physical and tracking.

The present invention is aimed at one or more of the problems set forth above.

### SUMMARY OF THE INVENTION

In one aspect of the present invention, a method for tracking inventory composed of a plurality of items is provided. The method includes the steps of establishing ownership of a first number of the items by a first owner, establishing ownership of a second number of the items by a second owner, disposing of one of the items in a transaction, and establishing ownership of the disposed one of the items as a function of a parameter of the transaction.

In another aspect of the present invention, a method for tracking inventory composed of a plurality of items is provided. The method includes the steps of placing a first portion of the items at a first location, placing a second portion of the items at a second location, establishing ownership of a first number of the first portion of the items by a first owner, establishing ownership of a second number of the first portion of the items by a second owner, establishing ownership of a third number of the second portion of the items by the first owner, and establishing ownership of a fourth number of the second portion of the items by the second owner. The method further includes the steps of disposing of one of the items in a transaction, establishing ownership of the disposed one of the items as a function of a parameter of the transaction, and adjusting one of the first, second, third, and fourth numbers as a function of the established ownership of the disposed one of the items.

In a further aspect of the present invention, a system for tracking inventory composed of a plurality of items is provided. The system includes a database for storing inventory data and a controller. The controller is coupled to the database and is adapted to establish ownership of a first number of the items by a first owner, establish ownership of a second number of the items by a second owner, dispose of one of the items in a transaction, and establish ownership of the disposed one of the items as a function of a parameter of the transaction.

### BRIEF DESCRIPTION OF THE DRAWINGS

FIG. 1 is a diagrammatic illustration of a control system for tracking inventory composed of a plurality of items, according to an embodiment of the present invention;

FIG. 2 is a flow diagram of a method for tracking inventory composed of a plurality of items, according to an embodiment of the present invention;

FIG. 3 is a flow diagram of a method for tracking inventory composed of a plurality of items, according to another embodiment of the present invention;

FIG. 4A is a first chart illustrating operation of a method for tracking inventory, according to an embodiment of the present invention;

FIG. 4B is a second chart illustrating operation of the method of FIG. 4A, according to an embodiment of the present invention;

FIG. 4C is a third chart illustrating operation of the method of FIG. 4A, according to an embodiment of the present invention;

FIG. 4D is a fourth chart illustrating operation of the method of FIG. 4A, according to an embodiment of the present invention;

FIG. 4E is a fifth chart illustrating operation of the method of FIG. 4A, according to an embodiment of the present invention; and,

FIG. 4F is a sixth chart illustrating operation of the method of FIG. 4A, according to an embodiment of the present invention.

### DETAILED DESCRIPTION

With reference to the drawings and in operation, the present invention provides a system 100 and methods 200, 300 for tracking inventory. The inventory includes a plurality of items 102 which are the same or similar. The method is aimed at tracking ownership of the items 102, where the items 102 may be owned by different owners. For example, if there are two (2) owners, then a first number of the items 102 are owned by the first owner and a second number of items 102 are owned by the second owner. In one embodiment, the items 102 are the same or similar, i.e., the items 102 are indistinguishable. The method may be performed manually or implemented as part of a computer-based inventory system (see below).

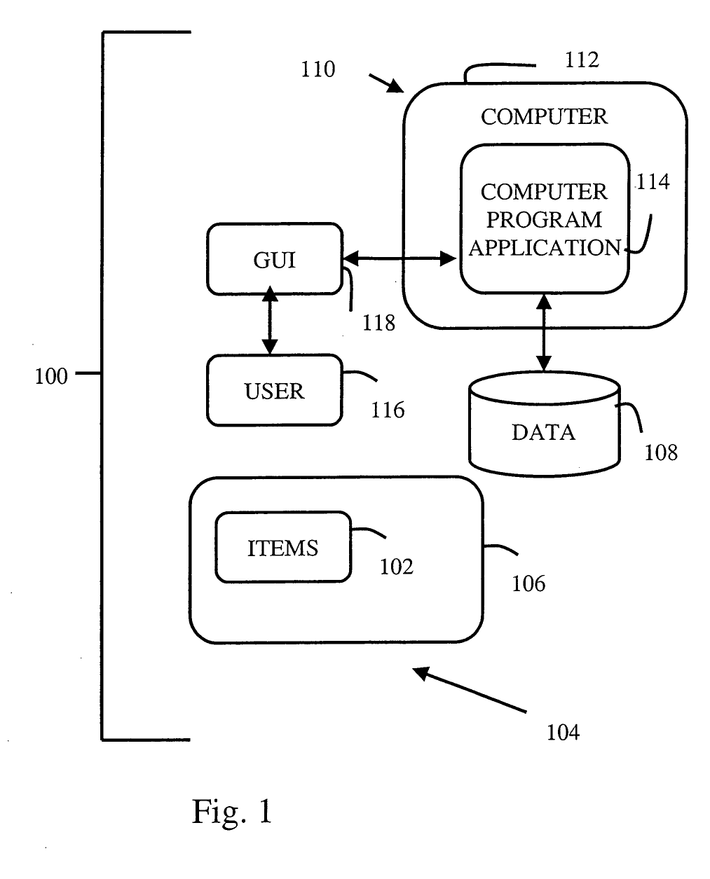

With specific reference to FIG. 1, the computer system 100 for tracking inventory according to an embodiment of the present invention, will now be described. The inventory is composed of a plurality of items 102 located at one or more locations 104. The items 102 are stored appropriately, in container(s), bin(s), racks(s) 106, etc. . . .

The system 100 includes a database 108 for storing inventory data and a controller or control system 110 coupled to the database 108. The controller 110 includes a computer 112 adapted to run a computer program application 112 in a conventional manner. In one embodiment, the computer 112 is a stand alone computer 112 operable by a user 116 through a graphical user interface (GUI) 118. In another embodiment, the present invention is embodied in a computer system connected by a network (not shown).

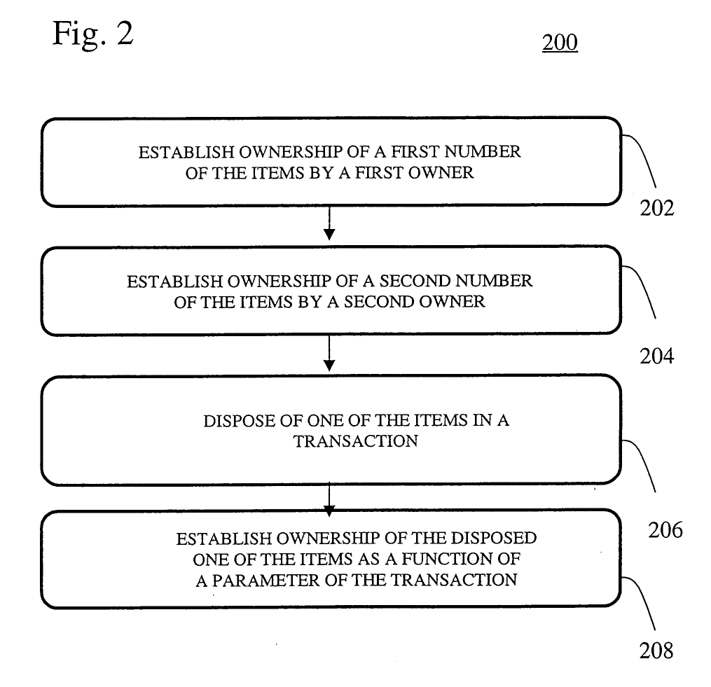

With particular reference to FIG. 2, a method 200 for tracking inventory of a plurality of owners according to an embodiment of the present invention will now be discussed. The method 200 may be implemented using the system 100 described above or manually (using a paper tracking system).

In a first process step 202, ownership of a first number of the items 102 by a first owner is established. In a second process step 204, ownership of a second number of the items 102 by a second owner is established. It should be noted the first and second number refer to the number of items 102 that each owner owns. However, an owner is not prescribed for each individual item 102. For example, of there are a total of N items, it is established that the first owner owns n items and that the second owner owns m items. However, the owner of a particular one of the items 102 is not established.

Returning to FIG. 2, in a third process block 206, one of the items 102 is disposed in a transaction. In a fourth process block 208, ownership of the disposed one of the items 102 is established as a function of a parameter of the transaction.

In one embodiment, the method 200 includes the step of adjusting one of the first and second numbers as a function of the established ownership of the disposed one of the items 102. In one embodiment, the transaction is a sale of the disposed one of the items 102. In another embodiment, the transaction is a manufacturing process. In still another embodiment, the transaction is incorporation of the disposed item 102 into an article of manufacture.

In one embodiment the method 200 includes the step of storing all of the items 102 in a container 106. As stated above, ownership of a specific item 102 within the container 106 is not established.

In another embodiment, the method 200 includes the step storing the items 102 in a plurality of containers 106 at a single location 104, wherein ownership of a specific item 102 at the single location 104 is not established.

In still another embodiment, the method 200 includes the step of storing the item 102 at a plurality of locations 104, wherein ownership of a specific item 102 at the plurality of locations 104 is not established.

In one embodiment, the method 200 includes the steps of establishing a forecast of demand for the item 102 and ordering a number of the items 102 to meet the forecast. The step of ordering a number of the items 102 is performed by one of the first and second owners. The method 200 further includes the steps of receiving the items 102 and transferring an appropriate number of the items 102 to the other of the first and second owners.

In one embodiment, a first portion of the items 102 is stored at a first location 104 and a second portion of the items 102 is stored at a second location 104. As stated above, ownership of a specific item 102 is not established. The method 200 includes the step of forecasting a need of the items 102 at one of the first and second locations 104.

In one embodiment, the parameter of the transaction is the country of intended use. The country of intended use includes the country where the item 102 is being shipped or sold, where the product manufactured using the item 102 is being shipped or sold, or where the article of manufacture incorporating the item 102 is being shipped or sold.

In another embodiment, the parameter of the transaction is geographic location. For example, the geographic location may include a state or province within a country.

In still another embodiment, the transaction is a sale to a buyer and the parameter is a name of the buyer.

In still one more embodiment, the transaction is initiated by an order, the order is received by one of a plurality of methods, and the parameter is of the one method in which the order was received. For example, the transaction may be a sale at a dealer, a sale over the internet, or a telephone sale.

In still a further embodiment, the transaction is a sale to a buyer and the parameter is a type associated with the buyer.

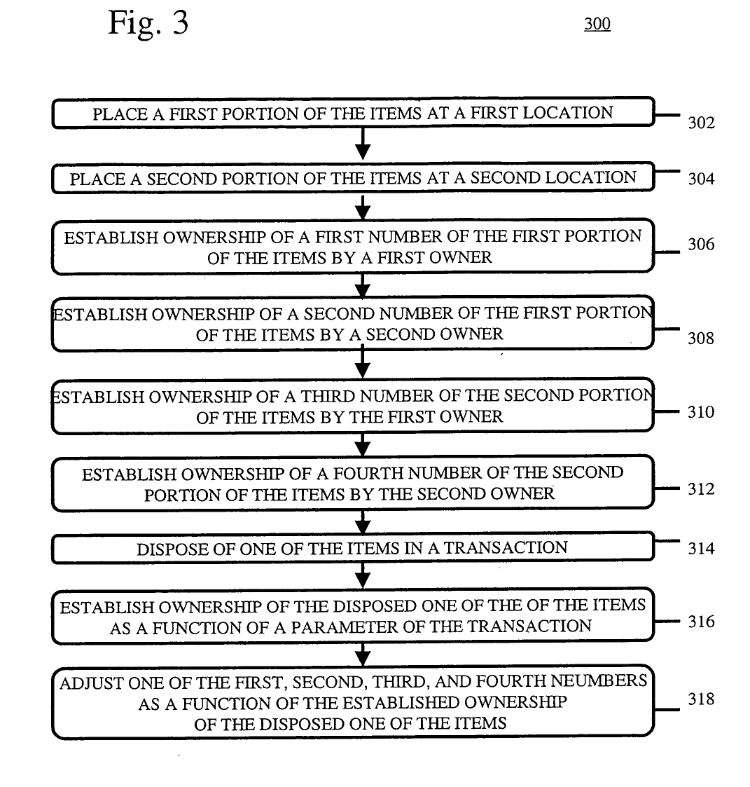

With reference to FIG. 3, a method 300 for tracking inventory composed of a plurality of items 102 according to a second embodiment of the present invention will now be discussed.

In a fifth process step 302 a first portion of the items 102 is placed or located at a first location 104. In a sixth process step 304, a second portion of the items 102 is placed or located at a second location 104.

In a seventh process step 306, ownership of a first number of the first portion of the items 102 by a first owner is established. In an eighth process step 308, ownership of a second number of the first portion of the items 102 by a second owner. In a ninth process step 310, ownership of a third number of the second portion of the items 102 by the first owner is established. In a tenth process step 312, ownership of a fourth number of the second portion of the items 102 by the second owner is established.

In an eleventh process step 314, one of the items 102 is disposed in a transaction. In a twelfth process step 316 ownership of the disposed one of the items 102 is established as a function of a parameter of the transaction. In a thirteenth process step 318, one of the first, second, third, and fourth numbers is adjusted as a function of the established ownership of the disposed one of the items 102.

### INDUSTRIAL APPLICABILITY

With reference to the Figs., the present invention provides a system 100 and methods 200,300 for tracking inventory for a plurality of items. The inventory includes a plurality of items 102 which are the same or similar. The method is aimed at tracking ownership of the items 102, where the items 102 may be owned by different owners. For example, if there are two (2) owners, then a first number of the items 102 are owned by the first owner and a second number of items 102 are owned by the second owner. In one embodiment, the items 102 are the same or similar, i.e., the items 102 are indistinguishable. The method may be performed manually or implemented as part of a computer-based inventory system (see below).

In one embodiment, the database 108 and the computer program application 114 are implemented within a spreadsheet file adapted to be opened/executed via a spreadsheet program, such as Microsoft® Excel. The GUI 118 is implemented on a sheet of the spreadsheet file.

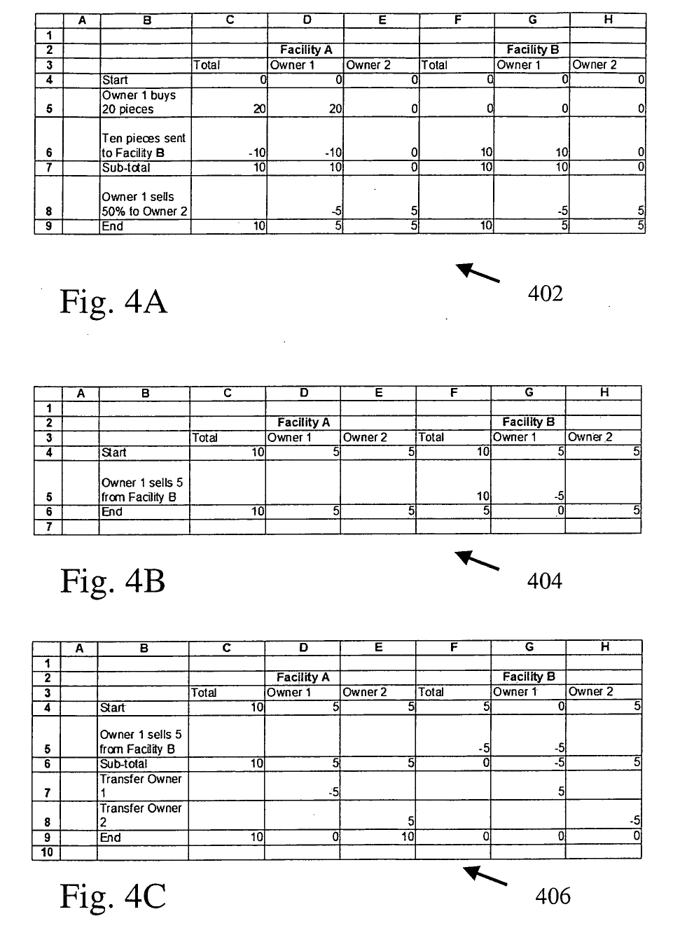

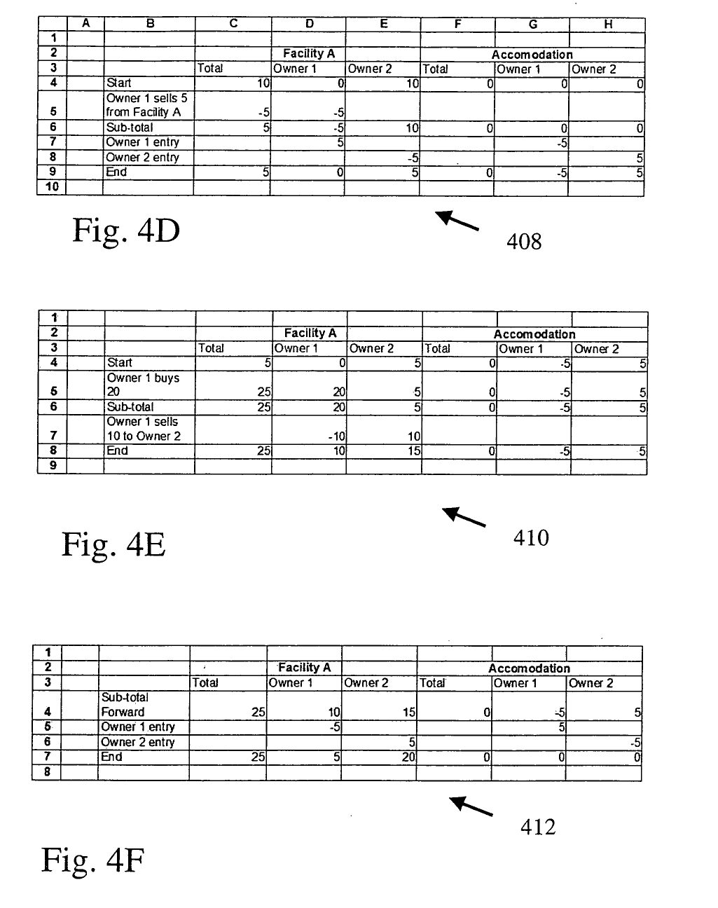

With references to FIGS. 4A-4F, exemplary transactions and how they are handled by the system 100 and method 200,300 will now be discussed. FIGS. 4A-4G show first, second, third, fourth, fifth, sixth and seventh charts 402, 404, 406, 408, 410, 412, 414 implemented in a spreadsheet file. The charts are mainly for illustrative purposes and may not be implemented as part of the invention. The following examples are discussed with regard to two owners: Owner 1 and Owner 2. However, it should be understood that the present invention is applicable to tracking ownership of items with more than two (2) owners.

In a first example, detailed in FIG. 4A, Owner 1 forecasts a worldwide demand for a part or item, Part “X”. The forecast establishes the demand for the part to be sold by Owner 1 and Owner 2. At the start of the example (line 4 of the illustrative spreadsheet), there are zero (0) parts. Owner 1 then orders the total quantity of parts, e.g., 20, from a supplier. This allows the owners to take advantage of volume pricing. The supplier then delivers the parts to a designated facility, such as a United States based inventory facility, Facility A.

When the parts arrive at Facility A, the parts are stored in a single bin, container, or rack. Alternatively, the pieces may be stored in multiple storage bins, containers, or racks. However the parts are not segmented based on ownership. Initially, Owner 1 owns all twenty parts. This is reflected in line 5 of FIG. 4A.

The inventories of Owner 1 and Owner 2 are thus consolidated. In the present example, two facilities are to be used, Facility A and Facility B. However, it should be understood that more than two facilities may be used.

After the parts are received at Facility A, a determination is made to send one-half (½) of the parts to Facility B. This determination may be made on a forecast that indicates that fifty percent (50%) of the orders for the part will come into Facility B. It should also be noted that ½ of the parts could have been delivered directly to Facility B from the supplier. Line 6 of the chart 402 reflects the sending of ½ the parts to Facility B. The Total of parts at Facility A is reduced by 10. The number of parts owned by Owner 1 at Facility A is reduced by 10. The number of parts at Facility B is increased by 10. And the number of parts owned by Owner 1 at Facility B is increased by 10. Line 7 reflects the new sub-totals.

Once the pieces are stored in the facilities, the parts may be allocated by the tracking system. Allocation is the step of determining how many pieces will be owned by Owner 1 and how many pieces will be owned by Owner 2. For example, based on the forecast, a determination may be made that of all shipments from a suppler, 50% will be owned by Owner 1 and 50% will be owned by Owner 2. The ratio may vary from owner to owner, part type to part type, and facility to facility. In this example, the ratio is 50% for part X at both facilities.

Line 8 shows the sale of ½ the parts to Owner 2. One half (½) or five (5) of the parts located at Facility A and five (5) of the parts located at Facility B are sold to Owner 2 (as seen on line 8). The totals at the end of the transaction are shown in line 9.

The ratio may vary from one supply shipment to the next or from one time period to the next and is maintained at the part number/facility level.

With reference to FIG. 4B, an order is then received from a buyer to purchase five (5) pieces of part X. Five pieces will be sold to the buyer. At this time, the owner of the five pieces to be sold may be determined. In accordance with the present invention, the owner of the five parts being sold is determined as a function of a parameter of the transaction, i.e., the purchase. In one embodiment, the parameter is whether the buyer is within the United States or external to the US, i.e., an export purchase. However, as stated above, other parameters may include, the location of the buyer within the US (state or region), the name of the buyer, the type of buyer, the manner in which the purchase request was received, one dealer vs. another dealer, etc. . . .

For example, assume Owner 1 is responsible for foreign sales and Owner 2 is responsible for US sales. An order from South America is received at Facility B for 5 parts. Since Owner 1 is responsible for foreign sales, the five pieces to be sold are determined to be those of Owner 1. This is illustrated in FIG. 4B. Owner 1's inventory is reduced accordingly, and any five (5) of the ten (10) pieces from Facility B may be taken and shipped to the buyer. At the time of shipment, ownership of the particular 5 parts to be shipped is logged as from those of Owner 1.

In another example shown in FIG. 4C, at the start there are 10 parts located at Facility A and 5 parts located at Facility B. Owner 1 and Owner 2 each own 5 parts at Facility A and Owner 2 owns 5 parts at Facility B. Owner 1 owns no parts at Facility B (see line 4). An order from South America is received at Facility B and Owner 1 is again responsible for foreign sales. Owner 1 does not have five (5) parts at facility B. Therefore, a substitution will be made. A substitution is a process where an order is received for Owner 1 to sell a part. However, while Owner 1 has parts to sell, Owner 1 does not have any parts to sell at the particular facility. Therefore, the parts to be sold may be substituted for Owner 1's parts. For example, the five parts at Facility B are taken, sold and shipped to the buyer. Again, at the time of the purchase, the ownership of the five pieces is identified as Owner 1 (see line 5).

Once the five parts are sold, Owner 1 has a negative 5 parts in Facility B and Owner 2 has a +5 parts in Facility B. The total, which is the actual number of parts at Facility B, is zero (see line 6, column F)

In order to eliminate the negative quantity, Owner 1 transfers 5 parts from Facility A to Facility B (line 7). Then Owner 2 transfers five (5) parts from Facility B to Facility A (line 8). There is not physical transfer of parts. The transfer simply takes place via the system 100 and method 200, 300.

The new totals are reflected in line 9. Owner 1 does not own any parts. Owners 2 owns 10 parts located at Facility A.

Based on the above transactions, Owner 1 does not own any more pieces of part X. There are only ten parts left, all owned by Owner 2 at Facility A (see line 1 on the fourth chart 408). Now an order is placed at Facility A for five parts to be exported. However, Owner 1 does not have five (5) parts even if all of Owner 1's parts from all facilities are combined. As explained below, Owner 1 needs five parts and Owner 2 provides 5 parts to Owner 1. This amount will be replenished the next time a supply is received (or from several shipments if necessary) from the supplier.

As shown in line 6 of the fourth chart 408, at Facility A there are a total of 5 parts. Owner 1 has a negative inventory of −5 parts and Owner 2 appears to have 10 parts. In order to eliminate the negative inventory quantity a set of accommodation columns (columns F-H) are used to track the fact that Owner 2 has provided five parts to Owner 1. In this manner, the actual inventory tracking column may then reflect the true number, i.e., that Owner 2 owns all five left at Facility A. The accommodation columns also reflect the fact that Owner 1 will provide five pieces to Owner 2 upon the arrival of the next shipment, or as soon as possible thereafter.

For example, as shown on line 5 of the fifth chart 410, Owner 1 orders 20 parts. If the ratio is 50% (see above), 10 parts will be sent to Facility B and 10 parts will remain at Facility A. For the purposes of the following discussion, however, all twenty parts remain at Facility A.

In line 7 of the fifth chart 410, Owners 1 sells 10 parts to Owner 2 at Facility A (according to the pre-established ratio—see above). Thereafter, the accommodation is cleared (see lines 5-6 of the sixth chart 412). Typically, distribution to Facility B is done prior to clearing accommodation. In addition, if after the distribution, Owner 1 does not have enough parts in Facility A to clear the accommodation, then a substitution is done first (see above) and then the accommodation is cleared.

It should be noted that the sequence of steps described above is implementation dependent and several different sequences may be used to achieve the same end results.

If for example, only six (6) pieces are received in the next shipment, then assuming a 50/50 split, the system 100 and methods 200,300 would indicate 11 total parts, 0 for Owner 1, 11 for Owner 2, and an accommodation of −2 for Owner 1 and an accommodation of +2 for Owner 2. In other words, Owner 1 uses the parts it does receive to reduce the accommodation.

Once a part is no longer being made, the part is not eligible for accommodations. From the “stranded accommodation” perspective, the focus is on the fact that no further receipts are expected for the part. Without receipts, the accommodations can not be settled between the owners. However, if a part does become ineligible for processing using the system 100 and methods 200, 300, the receipt ratios described above will no longer apply and existing quantities will be exhausted following the above logic. In one embodiment, the accommodation is allowed to “ride” for a specified period of time, e.g., six months. If the accommodation is not resolved at the end of the time period, then the owner needing to clear the accommodation gets a return of the parts from the other owner and thereby settles the accommodation.

Other aspects and features of the present invention can be obtained from a study of the drawings, the disclosure, and the appended claims.

1-26. (canceled)

27. A method for tracking inventory of a plurality of items having a first portion owned by a first owner and a second portion owned by a second owner, comprising the steps of:
disposing of a quantity of items from the first portion in excess of an available quantity;
supplying a quantity of items from the second portion sufficient to fulfill the disposition; and
creating at least one of a substitution and an accommodation of the quantity of items from the second portion.

28. A method, as set forth in claim 1, wherein creating at least one of a substitution and an accommodation includes the step of creating a substitution in response to the first owner having a quantity of items at another location to substitute for the quantity of items from the second portion.

29. A method, as set forth in claim 2, further including the step of clearing the substitution in response to replacing the quantity of items from the second portion with the quantity of items from the other location.

30. A method, as set forth in claim 1, wherein creating at least one of a substitution and an accommodation includes the step of creating an accommodation in response to the first owner having no additional quantity of items available.

31. A method, as set forth in claim 4, further including the step of clearing the accommodation in response to replacing the quantity of items from the second portion as a quantity of items owned by the first owner becomes available.

32. A method, as set forth in claim 4, further including the step of settling the accommodation in response to determining that the quantity of items are not replaceable.

33. A method, as set forth in claim 6, further including the step of returning the quantity of items to the second portion in response to settling the accommodation.

34. A method, as set forth in claim 5, further including the step of settling the accommodation in response to a predetermined period of time elapsing from the creation of the accommodation, the accommodation not being cleared during the period of time.

35. A method, as set forth in claim 8, further including the step of returning the quantity of items to the second portion in response to settling the accommodation.

36. A method for tracking inventory of a plurality of items having a first portion owned by a first owner and a second portion owned by a second owner, comprising the steps of:
disposing of a quantity of items from the first portion in excess of an available quantity;
supplying a quantity of items from the second portion sufficient to fulfill the disposition; and
creating a substitution of the quantity of items from the second portion in response to the first owner having a quantity of items at another location to substitute for the quantity of items from the second portion.

37. A method for tracking inventory of a plurality of items having a first portion owned by a first owner and a second portion owned by a second owner, comprising the steps of:
disposing of a quantity of items from the first portion in excess of an available quantity;
supplying a quantity of items from the second portion sufficient to fulfill the disposition; and
creating an accommodation of the quantity of items from the second portion in response to the first owner having no additional quantity of items available.
